(19) United States
(12) Patent Application Publication
(10) Pub. No.: US 2021/0362626 A1
(43) Pub. Date: Nov. 25, 2021

(54) CUSHION CARRIER MODULE FOR A VEHICLE SEAT, AND VEHICLE SEAT

(71) Applicant: Adient Engineering and IP GmbH, Burscheid (DE)

(72) Inventor: Ulrich Karthaus, Remscheid (DE)

(21) Appl. No.: 17/313,323

(22) Filed: May 6, 2021

(30) Foreign Application Priority Data
May 20, 2020 (DE) 10 2020 113 707.9

(51) Int. Cl. B60N 2/02

(52) U.S. Cl. CPC B60N 2/0284; B60N 2/0232

(57) ABSTRACT

A cushion carrier module for a vehicle seat may have a base element and a length-adjustable cushion carrier with at least one cushion carrier element which is displaceable relative to the base element in a longitudinal direction. The at least one cushion carrier element may be pivotable relative to the base element about an axis of rotation running parallel to a transverse direction.

### FIELD

A cushion carrier module for a vehicle seat may have a base element and a length-adjustable cushion carrier with at least one cushion carrier element which is displaceable relative to the base element in a longitudinal direction. A vehicle seat using the cushion carrier module is also disclosed.

### BACKGROUND

DE 10 99 866 A discloses a vehicle seat with a seat cushion which has a front part and a rear-side part. The dimensions of the front part are changeable in the longitudinal direction of the seat. In the case of this known seat, between the front part, which is formed with its own cover, and the rear-side part there is a separating joint in which small objects, such as crumbs, can fall. It is complicated to remove the small objects from the separating joint.

DE 41 04 440 A1 discloses a vehicle seat, with a seat cushion having a front part and a rear-side part, wherein the front part is adjustable in the longitudinal direction of the seat in order to set a desired seat depth of the seat cushion with respect to the rear-side part. In every desired seat depth setting of the seat cushion, the rear-side part of the seat cushion forms a cohesive, continuous seat cushion surface without a separating joint.

DE 10 2009 037 895 B3 discloses a seat structure of a vehicle seat with an approximately horizontally extending cushion carrier on which a cushion support forming a continuous seat surface rests, wherein the cushion carrier is arranged on a first seat structural element so as to be adjustable and settable in the longitudinal direction of the seat so as to set the seat depth, with a front edge of the cushion carrier, about which the cushion support is deflected by a certain extent towards the floor region of the vehicle and is guided at a guide. The end region of the guide that is closer to the floor region is mounted pivotably about a first pivot axis arranged in a fixed position on the first seat structural element and extending in the transverse direction of the seat, and is oriented towards the front edge of the cushion carrier.

The module and seat are based on the problem of improving a cushion carrier of the type mentioned at the beginning, and of providing a corresponding vehicle seat.

### SUMMARY

The problem is solved by a cushion carrier module for a vehicle seat, the cushion carrier module having a base element and a length-adjustable cushion carrier with at least one cushion carrier element which is displaceable relative to the base element in a longitudinal direction, wherein the at least one cushion carrier element is pivotable relative to the base element about an axis of rotation running parallel to a transverse direction.

Owing to the fact that the at least one cushion carrier element is displaceable in a longitudinal direction relative to the base element and is pivotable relative to the base element about an axis of rotation running parallel to a transverse direction, the at least one cushion carrier element together with a fixed cushion part and/or with at least one further cushion carrier element can form a length-adjustable cushion surface section, or can carry a length-adjustable cushion surface section, without a gap arising.

A length of the cushion carrier can be changeable by a pivoting movement of the cushion carrier element about the axis of rotation, preferably by pivoting movements of a plurality of cushion carrier elements about a respectively assigned axis of rotation. A length of the cushion carrier can be changeable by a combination of a longitudinal displacement of the at least one cushion carrier element with a pivoting movement of the cushion carrier element about the axis of rotation.

The at least one cushion carrier element can be upholstered. The at least one cushion carrier element can have a basic body, in particular made of plastic. A cushion can be fastened on the basic body. The cushion can have a cover, for example made of material or leather. The cushion can additionally have a foam part carrying the cover. Alternatively, the cushion carrier element supports a continuous cushion surface without itself being upholstered. The at least one cushion carrier element can thus form a partial region of a length-adjustable cushion surface for the vehicle seat, or alternatively can support a partial region of a length-adjustable cushion surface for the vehicle seat.

Preferably, at least two cushion carrier elements, for example precisely four cushion carrier elements, are arranged one behind another, as viewed in the longitudinal direction. At least three cushion carrier elements can be arranged one behind another in the longitudinal direction, wherein the distances in the longitudinal direction between in each case two adjacent cushion carrier elements of the three cushion carrier elements can be adjusted, in particular synchronously with respect to one another.

Two cushion carrier elements can partially overlap one another in the longitudinal direction. The distance between the two cushion carrier elements can thereby be changed without a gap arising between the cushion carrier elements. In the event of a distance which is as small as possible between two cushion carrier elements, the overlapping is preferably maximal. In the event of a greatest possible distance between two cushion carrier elements, the overlapping is preferably minimal. The cushion carrier preferably has a plurality of cushion carrier elements, of which adjacent cushion carrier elements overlap. One of the cushion carrier elements of the cushion carrier can overlap with a fixed cushion part.

At least two cushion carrier elements can be coupled kinematically to one another. Each of the cushion carrier elements has a dedicated axis of rotation, wherein the axes of rotation are parallel to one another. The pivoting movements of the cushion carrier elements about the axes of rotation are preferably coupled kinematically to one another. The pivoting movements of the cushion carrier elements about the axis of rotation are preferably coupled to a change in the distance between the cushion carrier elements.

The base element can have a linear guide in which the at least one cushion carrier element is at least indirectly linearly guided. The linear guide can be designed as a telescopic rail. The at least one cushion carrier element can be mounted on a spindle nut so as to be pivotable about the axis of rotation, wherein the spindle nut is guided linearly in the linear guide.

Each spindle nut can have a left-hand thread section and a right-hand thread section. The left-hand thread section can be arranged axially next to the right-hand thread section. The left-hand thread section and the right-hand thread section are preferably aligned with each other.

In each case two spindle nuts can be connected to each other by in each case precisely one spindle. The spindle can have a left-hand thread and a right-hand thread. The left-hand thread of the spindle can be screwed into a left-hand thread section of a spindle nut. The right-hand thread of the spindle can be screwed into a right-hand thread section of a further spindle nut. By rotation of the spindle in a first direction of rotation, the distance between the two spindle nuts can thus be increased, and, by rotation of the spindle in a second direction of rotation opposed to the first direction of rotation, can be decreased.

In each case two spindle nuts, thus in each case two cushion carrier elements, can be connected to a respective spindle. A cushion carrier element arranged between two cushion carrier elements can be connected to one of the adjacent cushion carrier elements by a spindle, and can be connected to the other adjacent cushion carrier element by a further spindle. A spindle can connect a cushion carrier element to a fixed cushion part.

A plurality of spindles can be connected to a common drive shaft in each case for conjoint rotation. Preferably, the spindles are axially displaceable with respect to the drive shaft. The drive shaft can have a profile section onto which corresponding inner profiles of the spindles are pushed. The profile section of the drive shaft and the corresponding inner profiles of the spindles are preferably designed in such a manner that the spindles are arranged on the drive shaft so as to be movable longitudinally with respect to the drive shaft, but are connected in the circumferential direction to the drive shaft for conjoint rotation. The drive shaft can be guided through the spindle nuts. The spindle nuts are preferably axially displaceable and freely rotatable with respect to the drive shaft.

The problem is also solved by a vehicle seat with a seat part, a backrest and a length-adjustable cushion surface, for example of the seat part or of the backrest, wherein a previously described cushion carrier module forms an infinitely variably length-adjustable cushion surface section of the cushion surface. A further part of the cushion surface can be formed by a fixed cushion part. The fixed cushion part can be fastened to a base element of the cushion carrier module. The base element can be fastened to a seat part of the vehicle seat. Alternatively, the fixed cushion part can be fastened directly to the seat part of the vehicle seat.

In summary and expressed in other words, a cushion carrier module is provided having a division of the cushion carrier, in particular of the cushion surface, into a plurality of individual displaceable segments which at the same time as they are displaced also rotate. The individual segments can be designed in such a manner that they always overlap even in the event of a change in distance and do not have any gap between the individual segments, or an opening arises specifically in partial regions for better ventilation of the seat surface. This creates a cushion element which can be adjusted in length in an infinitely variable manner, with as far as possible no gap arising between a fixed seat surface and the longitudinally adjustable cushion element, or the impression of a complete seat surface arising through the selection of suitable upholstery materials. The cushion carrier module can be used for adjusting the seat depth of a seat part. A further application can be a leg support or a foot rest. In particular in the case of low vehicle seats, in which there is greatly limited space between the vehicle floor and a seat surface, in comparison to the seat depth adjustment devices known from the prior art, sufficient adjustment regions can be realized such that the vehicle seat is comfortable for users of very different builds.

### BRIEF DESCRIPTION OF THE FIGURES

FIG. 1 shows schematically a side view of one embodiment of a vehicle seat with a cushion carrier module for the length adjustment of a cushion surface,

FIG. 2 shows a perspective view of the cushion carrier module according to FIG. 1,

FIG. 3 shows a side view of the cushion carrier module from FIG. 2, adjusted to a shortest length, with a base element of the cushion carrier module not being illustrated, and

FIG. 4 shows a view corresponding to FIG. 3, with the cushion carrier module being adjusted to a maximum length.

### DETAILED DESCRIPTION

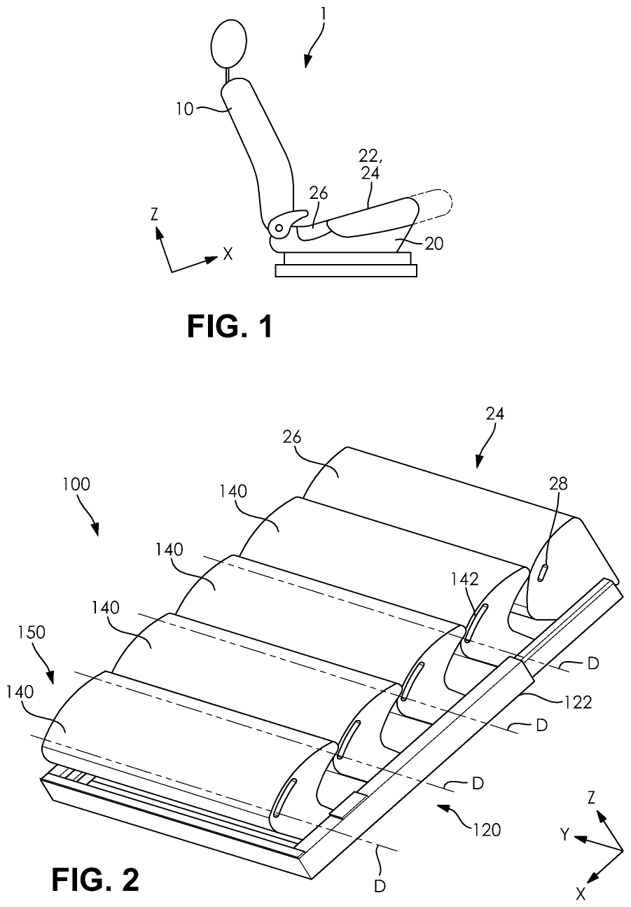

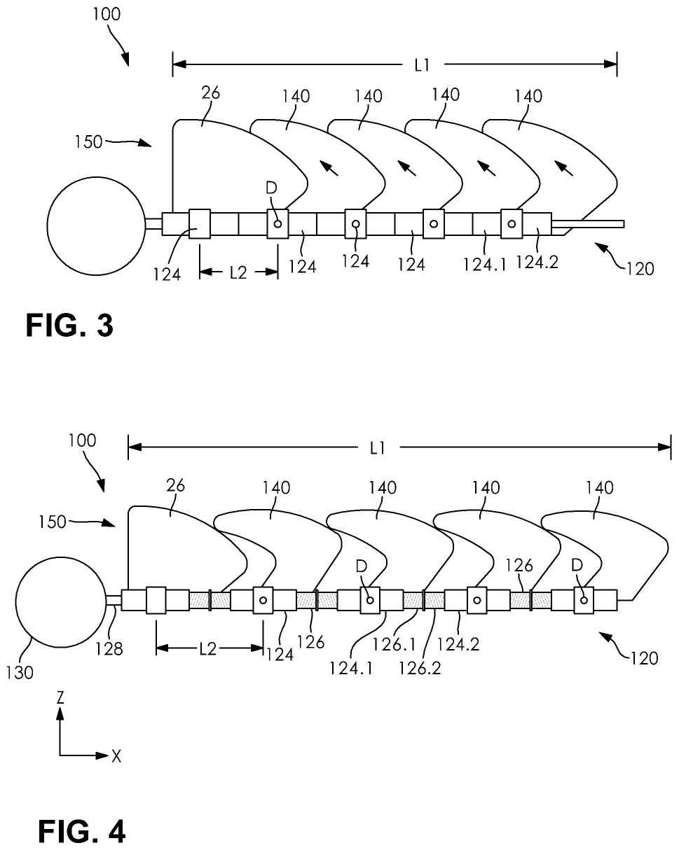

A vehicle seat 1 illustrated in FIG. 1 has a backrest 10 and a seat part 20. The seat part 20 has a length-adjustable cushion surface 22. FIG. 1 shows the cushion surface 22 in a shortest length, with a greatest length being illustrated by dashed lines. At least one cushion surface section 24 of the cushion surface 22 is length-adjustable by a cushion carrier module 100 illustrated in FIGS. 2 to 4. A fixed cushion part 26 is part of the cushion carrier module 100, but may also be part of the rest of the vehicle seat, in a modification of the exemplary embodiment.

The cushion carrier module 100 will be described below using three directions running in particular perpendicularly to one another. A longitudinal direction x runs parallel to a direction in which the cushion carrier module 100 is length-adjustable. A transverse direction y running in particular perpendicularly to a longitudinal direction x runs parallel to axes of rotation D about which the cushion carrier elements 140 are pivotable. A vertical direction z runs in particular perpendicularly to the longitudinal direction x and perpendicularly to the transverse direction y. The positional and directional details used refer to the previously described directions.

The cushion carrier module 100 is used in the seat part 20 to adjust a seat depth of the seat part 20. However, the cushion carrier module 100 can basically be used for adjusting the length of any upholstered elements of the vehicle seat, for example backrests, headrests, armrests, leg supports or foot rests.

The cushion carrier module 100 has a base element 120 and a cushion carrier 150 comprising a plurality of cushion carrier elements 140, here four cushion carrier elements 140. The individual cushion carrier elements 140 are upholstered and together form the length-adjustable cushion surface section 24. The individual cushion carrier elements 140 thus form the visible cushion surface section 24 of the seat part 20.

The cushion carrier module 100 is substantially mirror-symmetrical to a mirror plane running perpendicularly to the transverse direction y, and therefore only one side of the cushion carrier module 100 is described below. The other side (as viewed in the transverse direction y) is correspondingly constructed, with the cushion carrier elements 140 extending in the transverse direction y preferably over approximately the entire width of the vehicle seat and therefore not being arranged in mirrored form.

In a modification of the exemplary embodiment, the cushion carrier elements carry a cushion layer forming the cushion surface section, for example a plate-like foam part layer provided with a fabric cover. In this case, the cushion carrier elements themselves are not visible in the upholstered vehicle seat.

The cushion carrier elements 140 are preferably identical parts. The cushion carrier elements 140 each have an approximately L-shaped cross section with two limbs, as viewed in the transverse direction y. In each case a first limb is coupled to a spindle nut 124, which is assigned to the cushion carrier element 140, so as to be pivotable about an axis of rotation D assigned to the cushion carrier element 140. Each cushion carrier element 140 has its own spindle nut 124 and its own axis of rotation D, wherein all of the axes of rotation D are arranged offset parallel to one another and parallel to the transverse direction y. With the exception of the frontmost cushion carrier element 140, a second limb of each cushion carrier element 140 in each case overlaps a second limb of an adjacent cushion carrier element 140. As a result, irrespective of a distance L2, two adjacent cushion carrier elements 140 are in each case arranged next to one another without a gap. The distance L2 corresponds both to the distance between the spindle nuts 126 and, because of the pivotable connection of the cushion carrier elements 140 to a respective spindle nut 126, to the distance between respectively adjacent cushion carrier elements 140 in the region of the axes of rotation D.

Some of the cushion carrier elements 140 or all of the cushion carrier elements 140 preferably each have a guideway 142 in which a lug of an adjacent cushion carrier element 140 engages in such a manner that the pivoting movements of the cushion carrier elements 140 take place synchronously and depending on the distance L2 between the cushion carrier elements 140. Accordingly, the fixed cushion part 26 also has a guideway 28 for coupling to the adjacent cushion carrier element 140.

The cushion carrier elements 140 and optionally the fixed cushion part 26 form a length-adjustable cushion carrier 150 with an adjustable length L1.

The base element 120 has a linear guide 122, here a telescopic guide or a telescopic rail. The spindle nuts 124 of the individual cushion carrier elements 140 are guided displaceably in the longitudinal direction x in the linear guide 122.

Each of the spindle nuts 124 has a left-hand thread section 124.1 and a right-hand thread section 124.2 arranged axially next to the left-hand thread section 124.1.

In each case two spindle nuts 124 are connected to one another by in each case precisely one spindle 126. The spindle 126 can have a left-hand thread 126.1 and a right-hand thread 126.2. The left-hand thread 126.1 of the spindle 126 is screwed into a left-hand thread section 124.1 of a spindle nut 124. The right-hand thread 126.2 of said spindle 126 is screwed into a right-hand thread section 124.2 of a further spindle nut 124. By rotation of the spindle 126 in a first direction of rotation, the distance L2 between the spindle nuts 124 and a respectively adjacent further spindle nut 124 can thus be increased, and, by rotation of the spindle 126 in a second direction of rotation opposed to the first direction of rotation, can be decreased. In addition, the fixed cushion part 26 is connected by a corresponding spindle 126 to a spindle nut 124 of the directly adjacent cushion carrier element 140.

The spindles 126 are all connected to a common drive shaft 128 for conjoint rotation, but so as to be displaceable in the longitudinal direction x. The drive shaft 128 has a splined shaft profile on which the spindles 126 are pushed by a respective corresponding inner profile. The drive shaft 128 is guided through the spindle nuts 124 in such a manner that the spindle nuts 124 are axially displaceably and freely rotatable with respect to the drive shaft 128. The drive shaft 128 is drivable, that is to say adjustable, by an electric motor 130.

The features disclosed in the above description, the claims and the figures can be of importance both individually and in combination for implementing the device in its various configurations, to the extent that they remain within the scope of protection of the claims.

Expressions used in the claims, such as “comprise”, “have”, “include”, “contain” and the like do not exclude further elements or steps. The use of the indefinite article does not exclude a multiplicity. A single device can carry out the functions of a plurality of units or devices mentioned in the claims.

### LIST OF REFERENCE SIGNS

1 Vehicle seat
10 Backrest
20 Seat part
22 Cushion surface
24 Cushion surface section
26 Fixed cushion part
28 Guideway
100 Cushion carrier module
120 Base element
122 Linear guide
124 Spindle nut
124.1 Left-hand thread section
124.2 Right-hand thread section
126 Spindle
126.1 Left-hand thread
126.2 Right-hand thread
128 Drive shaft
130 Electric motor
140 Cushion carrier element
142 Guideway
150 Cushion carrier
L1 Length (of the cushion carrier 150)
L2 Distance (between two adjacent spindle nuts 126)
D Axis of rotation
x Longitudinal direction
y Transverse direction
z Vertical direction

What is claimed is:

1. A cushion carrier module for a vehicle seat, the cushion carrier module having a base element and a length-adjustable cushion carrier with at least one cushion carrier element which is displaceable relative to the base element in a longitudinal direction,
wherein the at least one cushion carrier element is pivotable relative to the base element about an axis of rotation running parallel to a transverse direction.

2. The cushion carrier module according to claim 1, wherein a length of the cushion carrier is changeable via a pivoting movement of the at least one cushion carrier element about the axis of rotation.

3. The cushion carrier module according to claim 2, wherein a length of the cushion carrier is changeable via a combination of a longitudinal displacement of the at least one cushion carrier element in the longitudinal direction with a pivoting movement of the cushion carrier element about the axis of rotation.

4. The cushion carrier module according to claim 1, wherein the at least one cushion carrier element is upholstered and forms a partial region of a length-adjustable cushion surface for the vehicle seat.

5. The cushion carrier module according to claim 1, wherein at least two cushion carrier elements are arranged one behind another in the longitudinal direction.

6. The cushion carrier module according to claim 1, wherein at least three cushion carrier elements are arranged one behind another in the longitudinal direction, wherein the distances in the longitudinal direction between in each case two adjacent cushion carrier elements of the three cushion carrier elements can be adjusted synchronously with respect to one another, with a simultaneous pivoting movement of the cushion carrier elements about the axes of rotation.

7. The cushion carrier module according to claim 1, wherein at least two cushion carrier elements are kinematically coupled to one another.

8. The cushion carrier module according to claim 7, wherein the pivoting movements of the cushion carrier elements about the axes of rotation are kinematically coupled to one another.

9. The cushion carrier module according to claim 1, wherein two cushion carrier elements partially overlap one another in the longitudinal direction.

10. The cushion carrier module according to claim 1, wherein the base element has a linear guide in which the at least one cushion carrier element is at least indirectly guided linearly.

11. The cushion carrier module according to claim 10, wherein the linear guide is designed as a telescopic rail.

12. The cushion carrier module according to claim 11, wherein the at least one cushion carrier element is mounted on a spindle nut so as to be pivotable about the axis of rotation, wherein the spindle nut is guided linearly in the linear guide.

13. The cushion carrier module according to claim 11, wherein the at least one cushion carrier element is coupled to a spindle nut so as to be pivotable about an axis of rotation, wherein the spindle nut has a left-hand thread section and a right-hand thread section arranged axially next to the left-hand thread section.

14. The cushion carrier module according to claim 13, wherein in each case two spindle nuts are connected via a spindle.

15. The cushion carrier module according to claim 13, wherein a plurality of spindles are connected to a common drive shaft in an axially displaceable manner and for conjoint rotation.

16. The cushion carrier module according to claim 15, wherein the drive shaft is guided through the spindle nuts, wherein the spindle nuts (124) are axially displaceable and rotatable with respect to the drive shaft.

17. A vehicle seat, comprising:
a seat part,
a backrest and
a length-adjustable cushion surface,
wherein a cushion carrier module forms an infinitely variably length-adjustable cushion surface section of the cushion surface,
the cushion carrier module having a base element and a length-adjustable cushion carrier with at least one cushion carrier element which is displaceable relative to the base element in a longitudinal direction,
wherein the at least one cushion carrier element is pivotable relative to the base element about an axis of rotation running parallel to a transverse direction.

18. The vehicle seat according to claim 17, wherein a further part of the cushion surface is formed by a fixed cushion part.
